(19) United States
(12) Patent Application Publication
(10) Pub. No.: US 2024/0312135 A1
(43) Pub. Date: Sep. 19, 2024

(54) METHOD FOR GENERATING A 3D MODEL HAVING INNER STRUCTURES

(71) Applicant: Hyperforge Holdings Pte Ltd., Singapore (SG)

(72) Inventor: Michael GALLO, Valeggio sul Mincio (IT)

(21) Appl. No.: 18/658,623

(22) Filed: May 8, 2024

Related U.S. Application Data
(63) Continuation of application No. PCT/EP2022/081171, filed on Nov. 8, 2022.

(30) Foreign Application Priority Data
Nov. 8, 2021 (DE) 10 2021 129 012.0

(51) Int. Cl. G06T 17/00; B29C 64/386; B33Y 50/00

(52) U.S. Cl. CPC G06T 17/00; B29C 64/386; B33Y 50/00

(57) ABSTRACT

A method for generating a digital model of a 3D object is provided, the 3D object being for subsequent printing by a 3D printer. The 3D object has an inner volume (I), and a structure (S) is defined for a predetermined portion (A) of the inner volume (I).

### CROSS REFERENCE TO RELATED APPLICATIONS

This application is a continuation under 35 U.S.C. § 120 of International Application PCT/EP2022/081171, filed Nov. 8, 2022, which claims priority to German Application No. 10 2021 129 012.0, filed Nov. 8, 2021, the contents of each of which are incorporated by reference herein.

### FIELD OF THE INVENTION

The invention relates to a method for generating a digital model of a 3D object for subsequent printing by means of a 3D printer.

### BACKGROUND OF THE INVENTION

In the field of 3D printing, it is well-known to represent a 3D object to be printed by means of a virtual 3D model or digital model. Typically, modeling is carried out by describing the surface of the 3D object. For this purpose, discretization (triangulation), parametrization (Bézier curves), or interpolation (polynomial interpolation) are used, for example.

It is also known that 3D objects have an inner volume. When modeling the surface, the inner volume of a 3D object is implicitly modeled as well. This allows solid 3D objects to be modeled and printed. Similarly to the modeling of the surface, inner structures can also be modeled. However, when modeling a structure in a subregion of the inner volume, all already modeled structures in the rest of the inner volume must always be taken into account, which results in considerable computational effort. The same will apply when inner structures need to be adjusted or modified.

### OBJECT OF THE INVENTION

The object of the present invention is therefore to provide a method with which 3D objects which are to have an inner structure can be generated more easily and, in particular, more efficiently.

### Solution According to the Invention

The object is achieved by a method having the features according to the independent claim. Advantageous further embodiments of the invention are given in the dependent claims.

Accordingly, a method is provided for generating a digital model of a 3D object for subsequent printing by means of a 3D printer. The 3D object has an inner volume, wherein the inner volume is bounded by a surface.

According to the method, a first voxel model is generated. The first voxel model represents the 3D object by means of a number of voxels. Here, a first number of voxels represent the inner volume and a second number of voxels represent the surface of the inner volume. The first number of voxels and the second number of voxels together form the number of voxels. The number of voxels is stored in a first tree structure.

A structure is defined for a predetermined portion of the inner volume. By means of the structure, a property is assigned to a number of volume regions of the portion.

The properties assigned to the volume regions of the portion are stored in the first tree structure as an attribute value of the voxels corresponding to the volume regions of the portion.

The structure may comprise one or more components, in particular geometric bodies.

Defining the structure may comprise calculating the structure according to a calculation rule.

The method according to the invention has the advantage that the inner structure of the 3D object, which can be defined in particular by geometric bodies, can be calculated for individual predetermined portions of the inner volume. When calculating the structure, it is accordingly no longer necessary to take into account the entire inner volume of the 3D object. This alone can significantly reduce the running time for calculating the inner structure.

The distribution of the structure calculation over individual predetermined portions of the inner volume is advantageously made possible by the 3D object and its inner volume being represented by means of a number of voxels that are stored in the first tree structure.

Furthermore, the voxelization (conversion of the volume into discrete voxels) according to the method according to the invention has the advantage that changing a structure of a predetermined portion of the inner volume has no effect on other portions of the inner volume. Rather, the structure in the affected portion of the inner volume can be calculated separately (and, if necessary, merged with the existing voxel model by means of logical operators). This effectively avoids complex and time-consuming recalculations of the entire digital model of the 3D object.

The tree structure represents the volume of the digital model. To this end, the tree structure divides the volume into a number of voxels. Here, a voxel describes a cuboidal volume subregion. In a particular embodiment of the tree structure, the voxels can be cube-shaped. A voxel can in turn be divided into a number of voxels. This creates hierarchy levels in the tree structure.

The spatial resolution of the voxel model can be set by means of a number of hierarchy levels. Advantageously, the tree structure has a maximum of three hierarchy levels. The first hierarchy level is a root node. The root node is assigned a predetermined number of subnodes in a second hierarchy level. The subnodes of the second hierarchy level are likewise assigned a predetermined number of subnodes of the third hierarchy level. It has proven advantageous if the predetermined number of subnodes is 4096 in each case.

The position of the tree structure in three-dimensional space relative to the voxel model, which represents the digital model, can be stored in the root node. The position is used to store the position and orientation of the voxel model in three-dimensional space. The position in three-dimensional space can thus be determined for the number of voxels on the second hierarchy level and the third hierarchy level, without the respective positions for the voxels needing to be stored.

Each voxel of the voxel model has an attribute. In the attribute, the property assigned to the respective voxel by means of the structure can be stored as an attribute value. For example, the property can be a distance to the surface of the structure. Depending on the specific value of the distance value, it can indicate whether an inner voxel belongs to the 3D object or not.

The properties assigned to the volume regions of the portion are stored in the first tree structure as an attribute value of the voxels corresponding to the volume regions of the portion.

It is advantageous if the calculation rule comprises at least one implicit function.

By means of the implicit function, the property, such as the belonging of the corresponding voxels to the structure, can be determined in the portion of the inner volume. The belonging indicates which voxels of the portion are part of the structure and which voxels do not belong to the structure.

The use of an implicit function has proven to be particularly advantageous. However, other functions, in particular combinations of different implicit functions, can also be used as a calculation rule.

An implicit function defines a geometric shape in three-dimensional space as a function of spatial coordinates. For each point in the volume of the digital model of the 3D object, a distance to the geometric shape defined by an implicit function can thus be determined. By combining several implicit functions, an inner volume of the 3D object can be structured in the digital model in this way.

A particular advantage of the calculation rules according to the invention (e.g., implicit functions) results in combination with storing in the corresponding voxels of the tree structure the attribute values determined by means of the calculation rules. This is because this avoids having to evaluate the entire volume of the 3D model for each calculation rule. Without using the voxels stored in the tree structure, a check must be made for each point of the inner volume for each calculation function whether or not the respective point belongs to the object of the calculation function. Neither is it therefore possible to process several calculation functions in parallel; they must necessarily be processed sequentially.

According to one aspect of the invention, the predetermined portion of the inner volume is selected such that the structure in the selected portion is fully modeled by the implicit function. The inner volume of the 3D object can thus be generated, for example, by a combination of copies of the portion in which the structure is modeled, i.e., without further calculations of implicit functions.

It is furthermore advantageous if a plurality of implicit functions is selected such that each implicit function assigns the property to a volume region of the number of volume regions of the portion.

It is particularly advantageous if the volume regions are disjoint volume regions, each of which is calculated as part of the structure by means of an implicit function.

According to an advantageous aspect of the invention, the property is selected from the group at least comprising:
the volume regions of the portion are volume regions that do not belong to the 3D object, so that the volume regions of the portion that belong to the object form a lattice-like structure,
material properties,
the material to be used for 3D printing, and
combinations thereof.

A lattice-like structure can thus be defined in the volume region of the portion by means of at least one implicit function. Alternatively, the implicit functions may also be used to define cavities in the portion of the inner volume, which essentially also form a lattice structure.

The properties assigned to the volume region of the portion, in particular the corresponding voxels thereof, can comprise various types of information. For example, the property can contain information about the belonging of the volume region or voxel to the inner volume of the 3D object. Further properties can be the color, the material, or a physical property.

Advantageously, the volume regions of the portion that do not belong to the 3D object and the volume regions of the portion that do belong to the 3D object have a common boundary surface. As an attribute value of the respective voxel, a distance of the voxel to the boundary surface is stored as a property.

The distance stored in a distance attribute of the voxel indicates that the respective voxel belongs to the surface of the inner volume or how far away the respective voxel is from the surface of the inner volume of the 3D object to be printed. Advantageously, the stored distance is the minimum distance, in particular perpendicular distance, of the voxel to the surface of the inner volume. A predetermined distance can also be stored in the distance attribute. The stored predetermined distance indicates that the respective voxel does not belong to the surface of the inner volume of the object to be printed or is far away from the surface of the inner volume.

In an advantageous embodiment of the method, control instructions for the 3D printer are derived from the attribute values stored in the first tree structure for voxels corresponding to the volume regions of the portion.

According to an advantageous aspect of the invention, a second voxel model is generated, wherein the second voxel model is stored in a second tree structure. The first voxel model and the second voxel model can have an identical spatial origin. The structure (S) is calculated in the second voxel model. In a merging step, the first voxel model and the second voxel model are merged by means of at least one logical operator.

It has also proven to be advantageous if the first voxel model has a first spatial resolution and the second voxel model has a second spatial resolution, wherein the first spatial resolution and the second spatial resolution differ at least in portions.

Preferably, the second voxel model has a third spatial resolution in a volume corresponding to the predetermined portion of the inner volume. The third spatial resolution may be finer or coarser than the second spatial resolution. The structure S in a volume region can thus, in particular, be calculated with a spatial resolution optimized for the structure.

In order to achieve a different spatial resolution, at least some nodes of the second hierarchy level can be assigned different numbers of subnodes (of the third hierarchy level).

Due to the use of voxel models, an overlay or combination of structures for generating the digital model can be designed extremely efficiently. For example, voxel models of structures can be stored in tree structures with different spatial resolution and can be merged to form the digital model. Depending on the property assigned to a structure, the spatial resolution of the tree structure can vary. While the property that encodes the belonging of a voxel to the 3D object usually requires the most precise spatial resolution possible, the property that, for example, encodes a printing material can be stored with a coarser spatial resolution as a second structure in the third tree structure (resultant tree structure). This is because the merging step assigns the corresponding printing material according to the second structure to only those voxels of the first voxel model that belong to the 3D object.

Advantageously, in the method according to the invention, a plurality of structures is calculated in parallel.

The parallel calculation of the plurality of structures can, for example, be carried out on a plurality of processors and/or a plurality of processor cores of one processor.

The parallel calculation of the plurality of structures is possible since the digital model of the 3D object is represented as a voxel model and the structures can each be calculated for individual, independent volume regions and the calculation for one volume region has no influence on the calculations in other volume regions. Only in a subsequent merging step are the structures combined or merged, whereby the digital model is generated. Each volume region can thus be processed on a different processor core or processor. The method according to the invention is accordingly highly parallelizable. As a result, the running time of the method can be significantly reduced if the processors or processor cores are scaled appropriately.

### BRIEF DESCRIPTION OF THE FIGURES

Further details and features of the method according to the invention become apparent from the following description in conjunction with the drawings. In the figures:

FIG. 1 shows a flowchart for a first embodiment of the method according to the invention;

FIG. 2 shows a flowchart for a second embodiment of the method according to the invention;

FIG. 3 shows an exemplary embodiment of the method according to the invention according to the second embodiment;

FIG. 4a shows a digital model of an inner volume having a cubic lattice structure, the digital model having been generated by means of the method according to the invention;

FIG. 4b shows a digital model of an inner volume having a gradually changing lattice structure, the digital model having been generated by means of the method according to the invention;

FIG. 5 shows a digital model of an inner volume having a second structure, the digital model having been generated by means of the method according to the invention;

FIG. 6a shows a digital model of an inner volume having a third structure, the digital model having been generated by means of the method according to the invention;

FIG. 6b shows a digital model of an inner volume having the third structure, the third structure becoming gradually denser along a direction through the inner volume;

FIG. 7 shows a digital model of an inner volume having a fourth structure, the digital model having been generated by means of the method according to the invention;

FIG. 8 shows a digital model of an inner volume having a flower-like lattice structure, the digital model having been generated by means of the method according to the invention;

FIG. 9 shows a digital model of an inner volume having a Schwarz-Primitive lattice structure, the digital model having been generated by means of the method according to the invention;

FIG. 10 shows a digital model of an inner volume having a seventh structure, the digital model having been generated by means of the method according to the invention;

FIG. 11a shows a digital model of an inner volume having a gyroid structure, the digital model having been generated by means of the method according to the invention;

FIG. 11b shows a digital model of an inner volume having a gyroid structure, the gyroid structure becoming denser along a direction of the digital model;

FIG. 12a shows a digital model of an inner volume having a Voronoi structure with open cells, the digital model having been generated by means of the method according to the invention;

FIG. 12b shows a digital model of an inner volume having a Voronoi structure with closed cells, the digital model having been generated by means of the method according to the invention;

FIG. 13 is a visualization for comparing the running time for generating a digital model of a 3D object having ten thousand structures between a method according to the prior art and the method according to the invention as a function of the number of parallel processors.

### DETAILED DESCRIPTION OF THE INVENTION

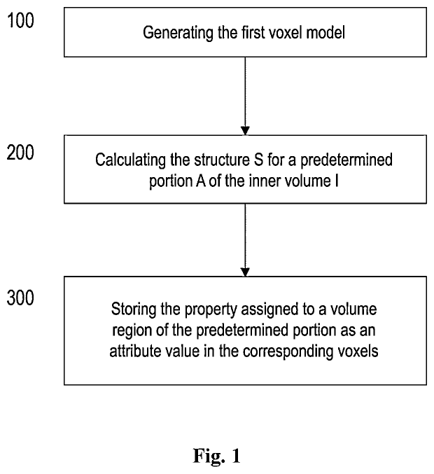

FIG. 1 shows the sequence of a first embodiment of the method according to the invention.

The method according to the invention serves to generate a digital model of a 3D object, wherein the 3D object has an inner volume. On the basis of the digital model, the 3D object can be printed by means of a 3D printer to form a physical object. The inner volume of the 3D object has a surface O.

In a first step 100 of the method, a first voxel model is generated. The first voxel model VM represents the 3D object by means of a number of voxels. Here, the number of voxels also represent the inner volume I and its surface O of the 3D object. The number of voxels VX is stored in a first tree structure.

In a second step 200 of the method, a structure for a predetermined portion of the inner volume I is calculated. Here, a property is assigned to a number of volume regions of the portion A by means of the structure S. The property may, for example, comprise information about the belonging of the volume region to the inner volume of the 3D object. The property may, for example, also comprise information about the color, the material, or a physical property of the volume region.

For calculating the structure S, a calculation rule is used which, in one embodiment of the invention, can comprise one implicit function or several implicit functions. The structure calculation can also be carried out by applying a mask or template, for example from a predetermined set of shapes. Described in the following are embodiments of the method according to the invention that are based on the use of implicit functions, which is however only used for illustrative purposes.

By means of implicit functions, geometric structures can be defined in three-dimensional space. Simple examples are, for example, a sphere function, a cylinder function, or a torus function. An evaluation of the implicit function over a volume region provides a boundary surface or surface of the (geometric) structure in the volume region.

The calculation or evaluation of the implicit function can be carried out by iteration over a volume region of the predetermined portion A. The implicit function can be evaluated iteratively for each voxel of the volume region. In this way, a distance to the structure or to the geometric body of the structure is determined for each voxel of the volume region. It can thus be determined for each voxel of the volume region whether it is located inside the structure, outside the structure, or on the surface O of the structure. On this basis, the property can be assigned to the volume region.

The structure can also be calculated from a combination of a plurality of implicit functions. By linking different implicit functions, even complex geometric bodies can thus be realized as a structure.

In a third step 300 of the method, the assigned properties are stored in the corresponding voxels of the volume region of the predetermined portion in the first tree structure. For this purpose, the voxels of the voxel model have an attribute. The assigned properties can be stored as an attribute value of the voxels corresponding to the volume regions of the portion A.

A particular advantage of the method according to the invention is that the evaluation of a structure S, in particular by using an implicit function, on a voxel model VM results in an advantage in the generation of a digital model of a 3D object. The structures of the inner volume I are typically small in comparison to the 3D object and can repeat regularly or irregularly in the inner volume of the 3D object. Such a structure can thus also be evaluated on a small volume region of the 3D object, i.e., a volume subregion, in particular if the entire surface O of the structure is contained in the volume subregion. For calculating a structure, in particular by means of an implicit function, only a part of the volume of the digital model thus needs to be evaluated in each case. On the other hand, with the methods mentioned at the outset, the entire surface model of the digital model must be updated. It is also advantageous that the running time of the method according to the invention for calculating a structure does not scale with the size of the 3D object but only with the size of the volume subregion of the digital model.

The first embodiment of the method according to the invention according to FIG. 1 is in particular suitable for generating periodic structures for the inner volume of the 3D object. In practice, the programming of a periodic structure can often be simplified considerably, for example by exploiting symmetries. A periodic structure on the volume regions of a single voxel model VM can thus be efficiently evaluated. Even a parallel calculation of the volume regions of the voxel model is possible. The parallel calculation can be carried out advantageously, in particular if the geometric bodies of the structures do not overlap and the volume regions are disjoint.

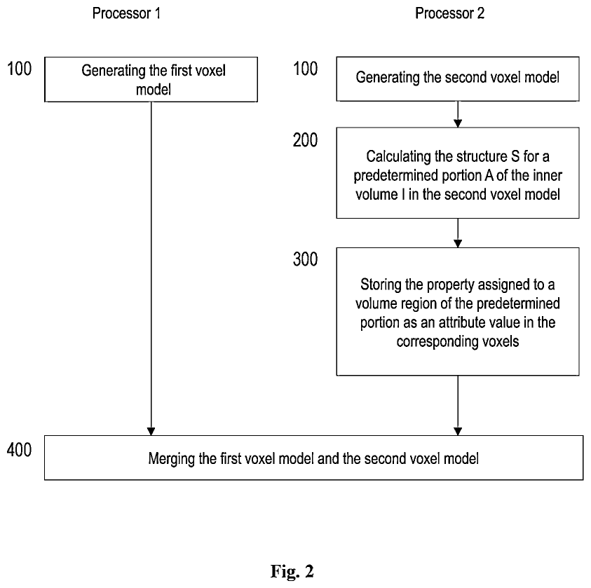

FIG. 2 shows the sequence of a second embodiment of the method according to the invention.

According to the second embodiment of the method according to the invention, both a first voxel model and a second voxel model are generated in the first step 100. While the first voxel model represents the 3D object by means of a number of voxels, the second voxel model serves to generate the structure S for a predetermined portion of the inner volume I of the 3D object. The second voxel model has a number of voxels that are stored in a second tree structure.

The origin of the second voxel model is identical to the origin of the first voxel model. However, the origin of the second voxel model can also be different from the origin of the first voxel model, in which case the two origins are put in relation to one another. By means of simple scalar operations, the voxels of the second voxel model can be represented in the coordinate system of the first voxel model. The advantage here is that structure in the second voxel model can be calculated completely independently of the first voxel model. Only when combining (merging) the voxel models do the voxels of the second voxel model have to be represented in the coordinate system of the first voxel model.

Furthermore, the second voxel model can have a spatial resolution and extent identical to the first voxel model. Likewise, the spatial resolution of the second voxel model may differ, at least partially, from the spatial resolution of the first voxel model. Preferably, the extent and spatial resolution of the second voxel model are adapted to the surface O of the inner volume I.

In the second step 200 of the method, a structure S is calculated for a predetermined portion of the inner volume I. The calculation of the structure is preferably carried out only in the second voxel model. Here, a property is assigned to a number of volume regions of the portion A by means of the structure S. The property corresponds to the property from the first exemplary embodiment (FIG. 1).

According to one aspect of the invention, the same structure can be calculated in the first voxel model and in the second voxel model. The respectively corresponding voxels can in this case be assigned different properties by means of the structure in the first voxel model and in the second voxel model.

For calculating the structure S in the second voxel model, it is also possible to use at least one implicit function. The procedure for calculating the structure S in the second voxel model can be carried out analogously to the calculation of the structure in a volume region of the first voxel model according to the first embodiment of the invention (FIG. 1).

In the third step 300 of the method, the assigned properties are stored in the corresponding voxels of the second voxel model in the second tree structure. Here, the voxels of the second voxel model have an attribute. The assigned properties can be stored as an attribute value of the voxels in the second voxel model. The second tree structure thus stores the structure that is to be generated in the inner volume of the first voxel model.

In a fourth step 400 of the method, the first voxel model and the second voxel model are combined (merged). For this purpose, the voxels of the first voxel model and of the second voxel model can be linked by means of a logical operator. Likewise, the number of voxels of the second voxel model can be inserted into a predetermined volume region of the first voxel model by means of a logical operator. In particular, the number of voxels of the second voxel model can be merged by means of the Boolean operator with voxels corresponding to the predetermined volume region of the first voxel model. Merging the two voxel models can be carried out in linear time.

By repeating steps 100 to 400, the digital model of the 3D object can be generated.

Generating the inner structure S in a second voxel model has the advantage that the second voxel model can have a spatial resolution adapted to the structure. This makes a high-resolution yet efficient calculation of the inner structure S in the second voxel model possible.

By shifting the calculation of the inner structure out to a second voxel model, the generation of the digital model can also be easily parallelized. Steps 100 to 300 can be carried out independently of one another in parallel on several instances of the second voxel model. For this purpose, several second voxel models can be generated and processed in a manner distributed across several processors and/or a plurality of processor cores. This is in particular advantageous if different functions are respectively used to calculate the structure for the second voxel models. The running time for generating a digital model of the 3D object can thus be significantly reduced. The several second voxel models can also be combined or merged with the first voxel model in parallel. Furthermore, a second voxel model can also be combined with the first voxel model multiple times in parallel, for example, be integrated into different spatial positions of the first voxel model.

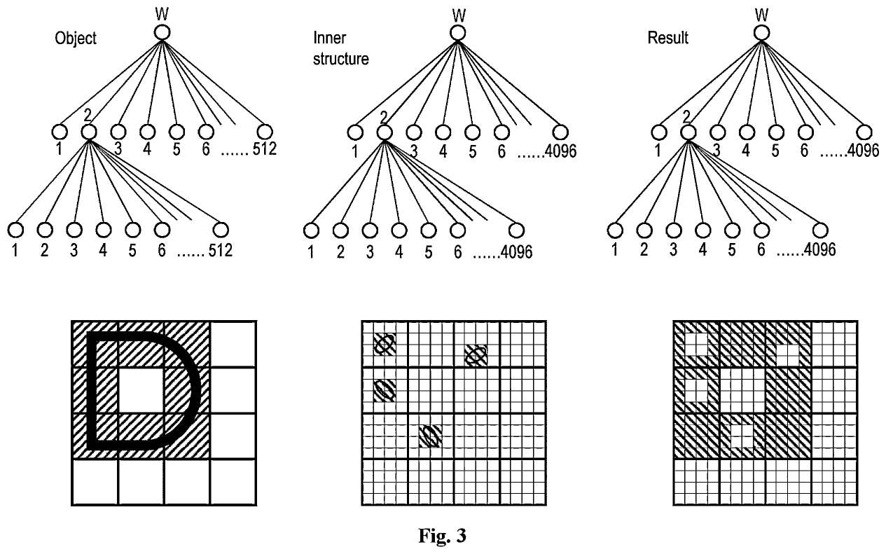

FIG. 3 shows an exemplary embodiment of the method according to the invention according to the second embodiment.

The left-hand column of FIG. 3 shows a cutting plane through a first voxel model. The first voxel model represents a 3D object. In the cutting plane shown, the 3D object has the shape of a D.

The first voxel model is stored in a first tree structure. The tree structure is shown above the shown cutting plane. The first tree structure has a root node W, which represents the first hierarchy level. In a second hierarchy level, the first tree structure has 512 subnodes. Each subnode of the second hierarchy level is assigned 512 further subnodes on a third hierarchy level. On the third hierarchy level, the spatial resolution of the first voxel model is accordingly 8×8×8 voxels. Accordingly, a portion comprising 4×4 voxels of the cutting plane of the first voxel model is shown. Due to the spatial resolution of the first voxel model, the D appears essentially as a square frame in the first cutting plane.

A second voxel model is shown in the center column of FIG. 3. In the second voxel model, four capsule-shaped structures with alternating spatial orientation were calculated. In the present exemplary embodiment, a capsule-shaped structure defines a (capsule-shaped) cavity in the inner volume I of the 3D object.

The second voxel model is stored in a second tree structure. The second tree structure is shown above the shown cutting plane through the second voxel model. The second tree structure has a root node W as the first hierarchy level. The root node comprises 4096 subnodes on a second hierarchy level. Each subnode of the second hierarchy level in turn has 4096 subnodes on a third hierarchy level. The spatial resolution of the second voxel model is accordingly 8 times finer than the spatial resolution of the first voxel model.

In the shown cutting plane of the second voxel model, the voxels corresponding to the calculated capsule-shaped structure are marked with oblique hatching.

The right-hand column of FIG. 3 shows the resulting voxel model after the fourth step 400 or merging step of the method according to the invention. In the course of combining the first voxel model with the second voxel model, the first spatial resolution (of the first voxel model) was adapted to the second spatial resolution (of the second voxel model). In this case, the spatial resolution of the resulting voxel model thus corresponds to the second spatial resolution. Accordingly, the design of the tree structure in which the resulting voxel model is stored corresponds to the design of the second tree structure.

When linking the first voxel model to the second voxel model, the second voxel model can be incorporated into the first voxel model. For this purpose, the first spatial resolution and/or the second spatial resolution is to be adjusted, if necessary. Likewise, the first voxel model can be incorporated into the second voxel model. Furthermore, it is possible that a resulting, third voxel model is generated from the first voxel model and the second voxel model.

Preferably, the first voxel model and the second voxel model have the same spatial extent. This means that the first voxel model and the second voxel model describe the same volume region.

Alternatively, the second voxel model can also have an extent adapted to the structure to be calculated. Since the first voxel model and the second voxel model have the same spatial origin, a second voxel model with a smaller extent can, for example, be linked with a predetermined volume region of the first voxel model.

According to one aspect of the invention, in the second voxel model, the volume regions in which the structure S is to be calculated have a third spatial resolution. Other volume regions of the second voxel model can accordingly have the second spatial resolution. Advantageously, the third spatial resolution is finer than the second spatial resolution. In the second tree structure, selected subnodes of the second hierarchy level can accordingly have fewer or more subnodes in the third hierarchy level. In this way, voxel models can be stored efficiently in the tree structure.

The right-hand column of FIG. 3 shows a cutting plane of the voxel model that results from the linking of the first voxel model to the second voxel model. In the square frame from the first voxel model, cavities on the basis of the second voxel model are accordingly marked as voids.

Control instructions for a 3D printer for printing the 3D object can be derived from the resulting voxel model.

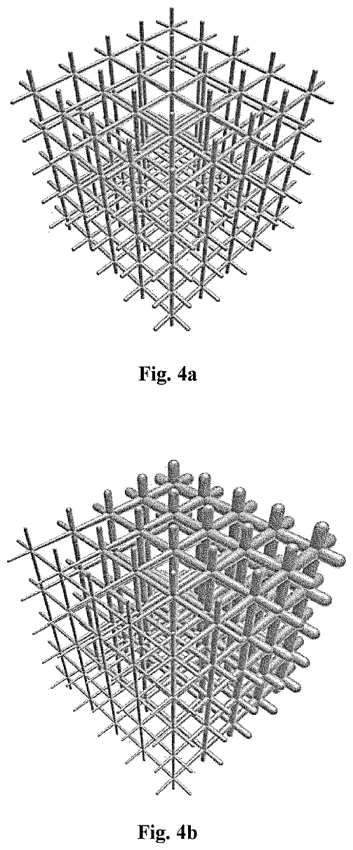

FIG. 4a shows a digital model of an inner volume having a cubic lattice structure.

Due to the high symmetry of the cubic lattice structure, the portion of the digital model shown in FIG. 4a can be generated directly in a single voxel model. The lattice structure of the inner volume I is composed of three cylindrical structures. The three cylindrical structures are aligned along three spatial directions orthogonally to one another. The cylindrical structures can, for example, be calculated by means of an implicit function. The voxel model of the cubic lattice structure shown in FIG. 4a has such a fine spatial resolution that the surface O of the inner volume I, i.e., the lattice structure, appears smooth.

FIG. 4b shows a digital model of an inner volume having a gradually changing lattice structure.

In contrast to the lattice structure of FIG. 4a, the cylinder radius of the cylindrical structures changes along a specified direction. The transition from a small cylinder radius at the one end of the inner volume to a wide cylinder radius at the other end of the inner volume I is smooth. In this case as well, the cylindrical structures can be calculated by means of implicit functions.

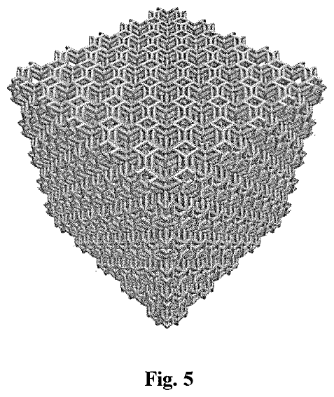

FIG. 5 shows a digital model of an inner volume having a second structure.

The digital model of an inner volume I shown in FIG. 5 is likewise represented by a voxel model. Shown is a lattice structure that is less symmetrical than the cubic lattice structure of FIG. 4a but still extends periodically over the volume region shown. It is therefore also advisable to carry out the structure calculation for this second structure directly in a single voxel model. The second structure can, for example, be calculated by an implicit function or a combination of implicit functions.

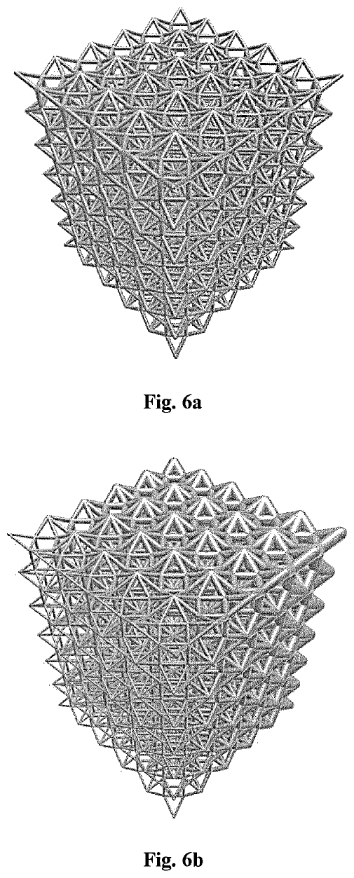

FIG. 6a shows a digital model of an inner volume having a third structure.

The third structure is also a regular structure in the shown volume region of the 3D object. The third structure can thus likewise be generated and stored directly in a voxel model. The third structure comprises a plurality of cylinders aligned and linked in a predetermined manner. The cylinders can, for example, be defined and calculated by implicit functions.

FIG. 6b shows a digital model of an inner volume having the third structure, the third structure becoming gradually denser along a direction through the inner volume.

According to the exemplary embodiment of FIG. 4b, the radius of the cylinders increases along a predetermined direction through the volume region shown. The transition from cylinders with a relatively small radius on the one side of the volume region to cylinders with a relatively large radius on the other side of the volume region is smooth.

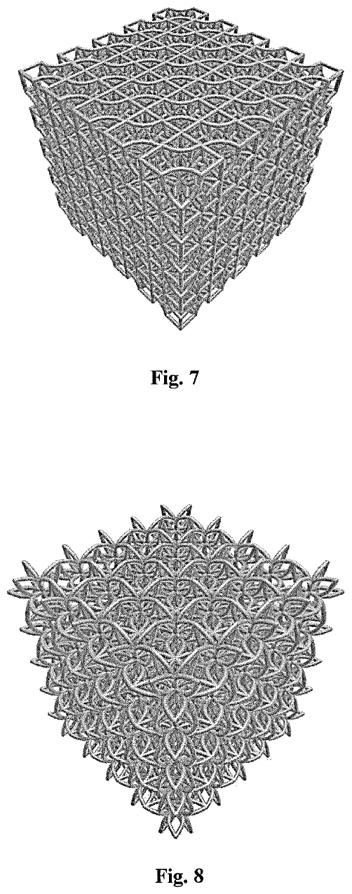

FIG. 7 shows a digital model of an inner volume having a fourth structure.

The fourth structure likewise has cylindrical structures. Furthermore, the fourth structure has wave-shaped structures, the wave-shaped structures being cylindrical at least in portions. The fourth structure can also be calculated by means of at least one implicit function on a volume region.

FIG. 8 shows a digital model of an inner volume having a flower-like lattice structure.

The lattice structure shown in FIG. 8 can also be calculated directly in a voxel model by means of an implicit function.

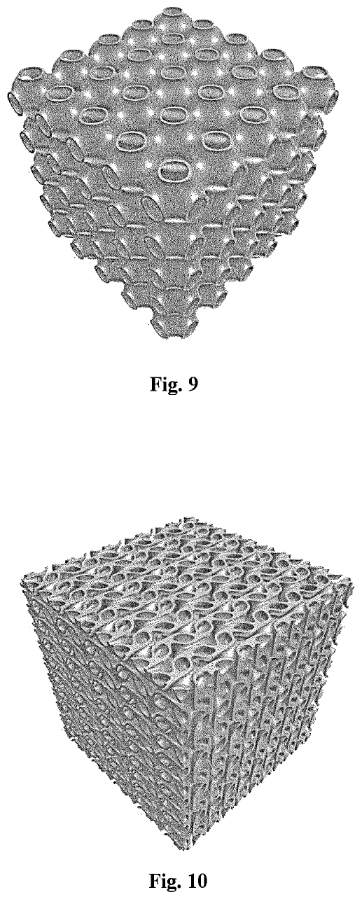

FIG. 9 shows a digital model of an inner volume having a Schwarz-Primitive lattice structure.

The Schwarz-Primitive lattice structure is a highly symmetrical and therefore regularly arranged lattice structure in the volume region. The structure can, for example, be defined by means of an implicit function.

FIG. 10 shows a digital model of an inner volume having a lidinoid structure.

The lidinoid structure has a triple periodicity. It is thus advantageous to calculate and store the seventh structure directly in a voxel model, for example by means of an implicit function.

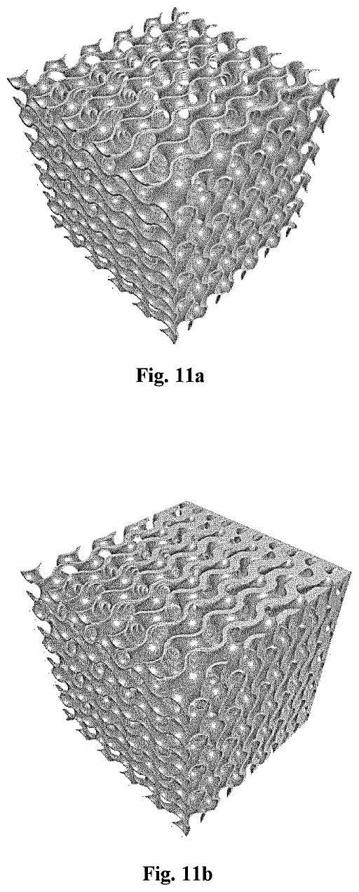

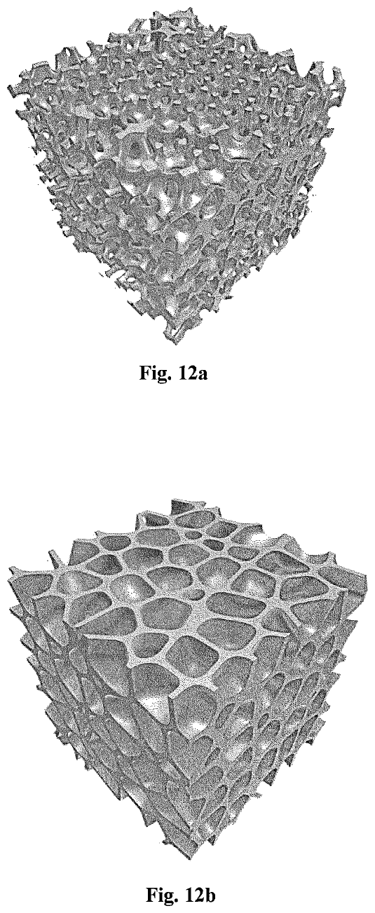

FIG. 11a shows a digital model of an inner volume I with a gyroid structure, which likewise has a triple periodicity. The gyroid structure of FIG. 11a is closely related to the lidinoid structure of FIG. 10.

FIG. 11b shows a digital model of an inner volume having a gyroid structure that becomes denser along one direction of the digital model.

The transition from one end of the gyroid structure with a low density to the other end of the gyroid structure with a higher density is smooth. The gyroid structure with a density changing along one direction can also be calculated by means of at least one implicit function.

FIG. 12a shows a digital model of an inner volume having a Voronoi structure with open cells.

Unlike the structures shown previously, the Voronoi structure is irregular or has no apparent periodicity. The Voronoi structure is formed starting from a number of starting points. The Voronoi structure can, for example, be calculated by means of an implicit function. Typically, this results in open cells, which in this form are, however, hardly feasible as the inner volume of a 3D object.

FIG. 12b shows a digital model of an inner volume having a Voronoi structure with open cells.

However, due to the voxelization of the digital model, the open cells of a Voronoi structure (as shown in FIG. 12a) can be efficiently converted to a structure with closed cells and thus be used to design an inner volume I of a 3D object.

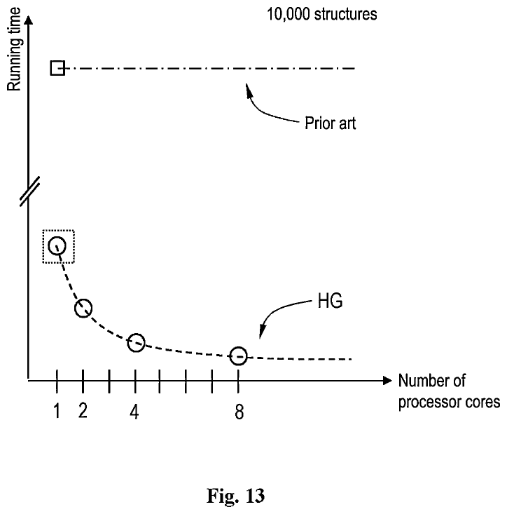

FIG. 13 visualizes a comparison of the running time for generating a digital model of a 3D object with ten thousand inner structures. A method according to the prior art (without voxel model) and the method according to the invention are compared.

Along the Y-axis, the running times of the methods are plotted as functions of the number of processor cores or processors for calculating 10,000 structures.

When the method is executed on only one processor, i.e., without parallelization, the method according to the invention is already considerably more efficient than a method from the prior art. This is because the 10,000 structures must be calculated in the prior art by means of 10,000 evaluations over the entire volume of the 3D model. However, according to the method according to the invention, it is sufficient to calculate the 10,000 structures in predetermined volume regions, each of which is adapted to the size of a structure. The running time difference therefore follows from the difference between the size of a structure and the size of the 3D object, which usually comprises several orders of magnitude.

The previously known methods from the prior art cannot be parallelized since it cannot be ruled out that structures S in the inner volume I overlap. The method according to the invention, denoted by HG, is, however, massively parallelizable. Accordingly, the running time decreases with increasing number of processors or processor cores, marked by round symbols. The parallelization of the method according to the invention is possible since the structures can be calculated in an outsourced manner in respective second voxel models. Several structures can be calculated in parallel in several second voxel models. By means of logical operators, merging of second voxel models and of the first voxel model representing the 3D object is efficiently possible.

In summary, the technical advantage of the method according to the invention results in particular from the voxelization of the digital model in combination with the knowledge of calculating the inner structure on volume regions of a portion of the inner volume separately and independently of other portions of the inner volume, the separate and independent calculation of the structures being possible only by using the voxel model described above. Dividing the inner volume into a plurality of predetermined volume regions, calculating the structures therein, and subsequently linking these calculated structures are possible in the first place due to the voxelization of the digital model. The same applies to the parallelization of the generation of a digital model for a 3D object and the associated reduction in running time. This allows the available computing power to be optimally utilized; processors or computer cores can be used in parallel.

For complex inner structures, it is even possible to calculate them on another data processing device. Thus, the first voxel model can, for example, be generated locally on a computer, and the inner structures of the first voxel model and the second voxel model itself can, for example, be calculated or generated in a cloud environment. The second voxel model can be transferred to the local computer and combined there with the first voxel model.

1. A method for generating a digital model of a 3D object for subsequent printing by means of a 3D printer, wherein the 3D object has an inner volume (I), wherein the inner volume (I) is bounded by a surface (O), and wherein
a first voxel model (VM) is generated, wherein
the first voxel model (VM) represents the 3D object by means of a number of voxels (VX),
a first number of voxels represent the inner volume (I) and a second number of voxels represent the surface (O), and
the number of voxels (VX) are stored in a first tree structure, and
a structure (S) is defined for a predetermined portion (A) of the inner volume (I), wherein a property is assigned to a number of volume regions of the portion (A) by means of the structure (S),
wherein the properties assigned to the volume regions of the portion (A) are stored as an attribute value of the voxels corresponding to the volume regions of the portion (A), in the first tree structure.

2. The method of claim 1, wherein defining the structure (S) comprises calculating the structure (S) according to a calculation rule.

3. The method of claim 2, wherein a plurality of calculation rules is selected such that, with each calculation rule, the property is assigned to a volume region of the number of volume regions of the portion (A).

4. The method of claim 3, wherein the volume regions are disjoint volume regions, each of which is assigned the property by means of a calculated structure (S), wherein the structure is calculated for at least two volume regions according to different calculation rules.

5. The method of claim 1, wherein the property is selected from the group at least comprising:
the volume regions of the portion (A) are volume regions that do not belong to the 3D object, so that the volume regions of the portion (A) that belong to the object form a lattice-like structure,
material properties,
the material to be used for 3D printing, and
combinations thereof.

6. The method of claim 5, wherein the volume regions of the portion (A) that do not belong to the 3D object and the volume regions of the portion (A) that belong to the object have a common boundary surface, wherein a distance (d) of the voxels to the boundary surface is stored as a property in the respective voxel.

7. The method of claim 1, wherein control instructions for the 3D printer are derived from the attribute values, stored in the first tree structure, of the voxels corresponding to the volume regions of the portion (A).

8. The method of claim 1, wherein
a second voxel model is generated,
the second voxel model is stored in a second tree structure,
the structure (S) in the second voxel model is defined, and
the first voxel model and the second voxel model are combined to form a resultant voxel model.

9. The method of claim 8, wherein combining the first voxel model and the second voxel model comprises merging by means of at least one logical operator.

10. The method of claim 8, wherein the resultant voxel model is the first voxel model or the second voxel model.

11. The method of claim 8, wherein a first spatial reference point is defined for the voxels of the first voxel model, and wherein a second spatial reference point is defined for the voxels of the second voxel model, wherein the relative position of the two spatial reference points to one another is included in the combination of the two voxel models.

12. The method of claim 8, wherein the first voxel model has a first spatial resolution and the second voxel model has a second spatial resolution, wherein the first spatial resolution is different from the second spatial resolution.

13. The method of claim 12, wherein the second voxel model has a third spatial resolution in a volume corresponding to the predetermined portion of the inner volume (I).

14. The method of claim 2, wherein the structures (S) are calculated at least partially in parallel.

15. The method of claim 8, wherein several second voxel models are generated for several structures, wherein several second voxel models are combined with the first voxel model in parallel.

16. The method of claim 8, wherein the second voxel model is combined with the first voxel model multiple times, preferably in parallel.

17. The method of claim 2, wherein the calculation rule comprises at least one implicit function.
